(19) United States
(12) Patent Application Publication
(10) Pub. No.: US 2012/0117068 A1
(43) Pub. Date: May 10, 2012

(54) TEXT MINING DEVICE

(75) Inventors: Takashi Onishi, Tokyo (JP); Shinichi Ando, Tokyo (JP); Satoshi Nakazawa, Tokyo (JP)

(73) Assignee: NEC CORPORATION, Tokyo (JP)

(21) Appl. No.: 13/382,485

(22) PCT Filed: Apr. 8, 2010
(86) PCT No.: PCT/JP2010/002563

§ 371 Date: Jan. 5, 2012

(30) Foreign Application Priority Data
Jul. 7, 2009 (JP) 2009-160811

(51) Int. Cl. G06F 17/30

(52) U.S. Cl. 707/737; 707/E17.046

(57) ABSTRACT

The text mining device 300 includes a clustering section 301. The clustering section 301 performs clustering on a plurality of characteristic expressions extracted from a document set such that characteristic expressions, in which sentences to be referred to as original sentences are the same, are compiled in one cluster, based on the similarity in original document sets which are sets of documents including the respective characteristic expressions, the documents being of the document set. Consequently, the probability of repeatedly viewing the same original document by a user can be reduced reliably.

### TECHNICAL FIELD

The present invention relates to a text mining device for performing text mining processing based on a document set.

### BACKGROUND ART

A text mining device which extracts characteristic expressions, that is, expressions representing the characteristics of a document set, from the document set has been known. In the present description, a result of extracting, from a document set including at least one document, an expression appearing in a characteristic manner in the document set with use of a text mining technique is described as a “characteristic expression”.

Each characteristic expression consists of one or a plurality of words. For example, a case where characteristic expressions such as “patent”, “business/model” and “amendment” are extracted as a result of performing text mining on a document describing a recent patent trend, is assumed. It should be noted that “/” represents a delimiter between words.

Each of the words “patent” and “amendment” is an example of a characteristic expression consisting of one word, and “business/model” is an example of a characteristic expression consisting of two words (how to divide words to form character strings actually depends on a dictionary used for the text mining processing).

Further, characteristic expressions include not only expressions representing a plurality of continuous words but also expressions representing a dependency relation and/or a syntax relation between words. For example, characteristic expressions include expressions representing “claim” and “amendment” and representing that a dependency relation exists between “claim” and “amendment”.

Further, by using a text mining technique, when extracting characteristic expressions from a document set, it is possible to obtain characteristic expressions with use of a result of performing synonym processing and/or paraphrase processing for absorbing fluctuation of words and expressions having the same meaning.

It should be noted that a technique of extracting characteristic expressions is well known in the natural language processing technique or the text mining technique. This technique is disclosed in Non-Patent Document 1, “3.1 Information Extraction from Text”, for example,

The text mining device described above extracts characteristic expressions by counting the number of characteristic expressions included in the document and also calculating the degree of characteristic based on the information quantity criterion or the like with respect to each characteristic expression.

It should be noted that a characteristic expression is likely to be formed of a relatively small number of words. Accordingly, even if a user views a characteristic expression, it is difficult to understand what kind of characteristic of a set of text, which is a target for text mining, is represented by each characteristic expression. As such, a text mining device of this type has an original sentence referring function. An original sentence referring function is a function of outputting a sentence of a part where the characteristic expression appears in the document set, as an original sentence. With this function, a user is able to view not only the characteristic expression but also the surrounding context where the characteristic expression appears, as an original sentence. As a result, a user is able to understand the content represented by each characteristic expression.

However, if a text mining device is adapted to output an original sentence for each extracted characteristic expression, the text mining device may output the same original sentence with respect to a plurality of different characteristic expressions. This means that there is a case where a plurality of different characteristic expressions are extracted from the same original document. For example, in the case of a characteristic expression consisting of a plurality of words, if there are a plurality of characteristic expressions in which combinations of words are different, a plurality of characteristic expressions containing the same words may be extracted from the same document.

In that case, the probability that a user repeatedly views the same original sentence is relatively high. This means that a user is not able to understand the outline of the document set efficiently.

As such, a text mining device described in Patent Document 1 summarizes characteristic expressions with use of an inclusion relation and a duplication relation between the extracted characteristic expressions. Thereby, the probability that a user repeatedly views the same original sentence can be reduced.
Patent Document 1: JP 2006-31198 A
Non-Patent Document 1: Hideo Hayashida, Hiroshi Wakimori, “Text Mining Technology and Its Applications” [online], February 2005, Nihon Unisys, Ltd., [Searched on Jun. 30, 2009], the Internet <http://www.unisys.co.jp/tec_info/tr84/8403.pdf>

However, a plurality of different characteristic expressions extracted from the same document do not always have an inclusion relation or a duplication relation. As such, the text mining device described in Patent Document 1 is not able to regard characteristic expressions, not having an inclusion relation or a duplication relation, as identical to summarize them into one characteristic expression. Accordingly, there has been a problem that there is a case where the probability that a user repeatedly views the same original sentence cannot be reduced.

### SUMMARY

In view of the above, an object of the present invention is to provide a text mining device capable of solving the above-described problem, that is, “there is a case where the probability that a user repeatedly views the same original sentence cannot be reduced”.

In order to achieve the object, a text mining device, which is an aspect of the present invention, includes a clustering means for performing clustering on a plurality of characteristic expressions extracted from a document set such that characteristic expressions, in which sentences to be referred to as original sentences are the same, are compiled in one cluster, based on the similarity in the original document sets which are sets of documents including the respective characteristic expressions, the documents being of the document set.

Further, a text mining method, which is another aspect of the present invention, includes performing clustering on a plurality of characteristic expressions extracted from a document set such that characteristic expressions, in which sentences to be referred to as original sentences are the same, are compiled in one cluster, based on the similarity in the original document sets which are sets of documents including the respective characteristic expressions, the documents being of the document set.

Further, a text mining program, which is another aspect of the present invention, is a program for causing a text mining device to realize a clustering means for performing clustering on a plurality of characteristic expressions extracted from a document set such that characteristic expressions, in which sentences to be referred to as original sentences are the same, are compiled in one cluster, based on the similarity in the original document sets which are sets of documents including the respective characteristic expressions, the documents being of the document set.

As the present invention is configured as described above, the probability that a user repeatedly views the same original sentence can be reduced reliably.

### BRIEF DESCRIPTION OF DRAWINGS

FIG. 1 is a block diagram schematically showing functions of a text mining device according to a first exemplary embodiment of the present invention.

FIG. 2 is a flowchart showing a text mining program to be executed by the CPU of the text mining device according to the first exemplary embodiment of the present invention.

FIG. 3 illustrates characteristic expressions extracted by the text mining device according to the first exemplary embodiment of the present invention.

FIG. 4 is a table showing characteristic expression inclusion information acquired by the text mining device according to the first exemplary embodiment of the present invention.

FIG. 5 is a table showing characteristic expressions clustered by the text mining device according to the first exemplary embodiment of the present invention.

FIG. 6 is a block diagram schematically showing functions of a text mining device according to a second exemplary embodiment of the present invention.

FIG. 7 is a flowchart showing a text mining program to be executed by the CPU of the text mining device according to the second exemplary embodiment of the present invention.

FIG. 8 is a table showing characteristic sentences extracted by the text mining device according to the second exemplary embodiment of the present invention.

FIG. 9 is a block diagram schematically showing functions of a text mining device according to a third exemplary embodiment of the present invention.

FIG. 10 is a flowchart showing a text mining program to be executed by the CPU of the text mining device according to the third exemplary embodiment of the present invention.

FIG. 11 is an illustration conceptually showing processing for generating a characteristic sentence by the CPU of the text mining device according to the third exemplary embodiment of the present invention.

FIG. 12 is a block diagram schematically showing functions of a text mining device according to a fourth exemplary embodiment of the present invention.

### EXEMPLARY EMBODIMENTS

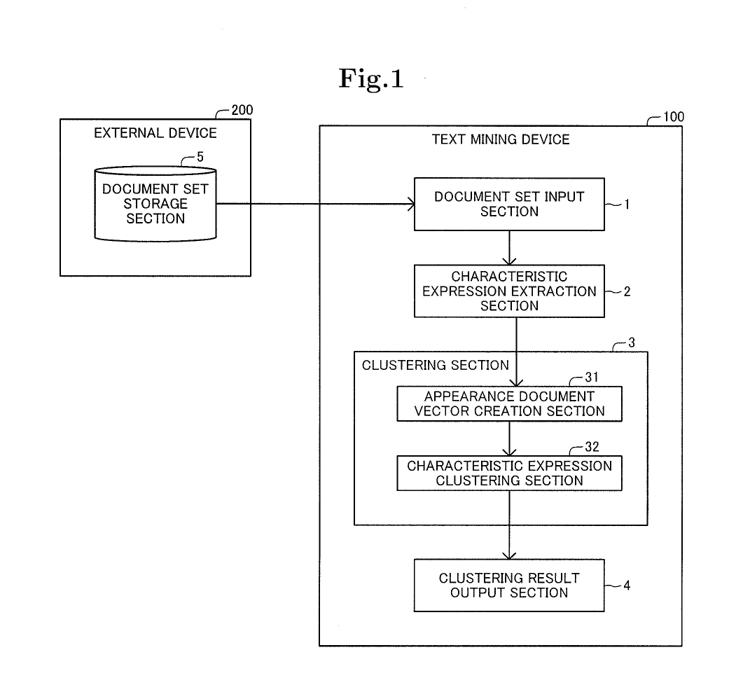

Hereinafter, exemplary embodiments of text mining devices, text mining methods, and text mining programs, according to the present invention, will be described with reference to FIGS. 1 to 12.

### First Exemplary Embodiment

First, a text mining device 100 according to a first exemplary embodiment will be described with reference to FIGS. 1 to 5. The text mining device 100 is an information processor including a CPU (Central Processing Unit) not shown, storage devices (memory and HDD (Hard Disk Drive)), an input device, and an output device.

The output device includes a display. The output device allows images formed of characters, graphics, and the like to be displayed on a display based on image information output from the CPU. The input device includes a keyboard and a mouse. The text mining device 100 is configured such that information based on operation by a user is input via the keyboard and the mouse.

The text mining device 100 is configured such that the functions, described below, are realized by the programs which are stored in the storage devices and executed by the CPU.

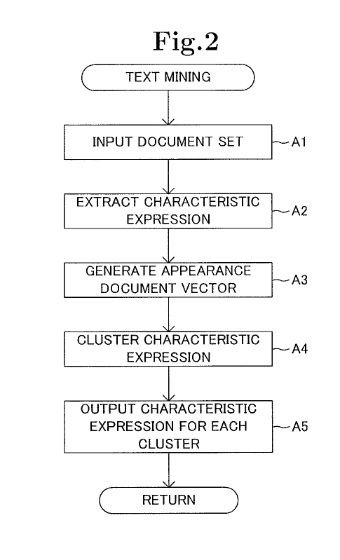

FIG. 1 is a block diagram showing the functions of the text mining device 100 configured as described above. These functions are realized by executing the programs shown in the flowchart of FIG. 2 and the like, by the CPU of the text mining device 100.

The functions of the text mining device 100 include a document set input section 1, a characteristic expression extraction section 2, a clustering section 3, and a clustering result output section (characteristic expression output means, original sentence output means) 4.

The document set input section 1 receives a document set stored in a document set storage section 5 provided in an external device 200 communicably connected with the text mining device 100, to thereby input (accept) the document set. The document set includes at least one document. A document is information representing character strings constituting sentences. The text mining device 100 may include a document set storage section 5.

The characteristic expression extraction section 2 performs a morphological analysis or a syntax analysis on the document set input by the document set input section 1 to thereby divide sentences included in the document set into analysis units each of which consists of one or a plurality of words. Further, by each analysis unit, the characteristic expression extraction section 2 calculates a frequency that each analysis unit appears in the document set and/or a criterion such as an information quantity criterion.

Then, based on the frequency and/or criterion calculated for each analysis unit, the characteristic expression extraction section 2 extracts a characteristic expression which is an expression representing the characteristics of the document set, from the document set. As a characteristic expression, an analysis unit appearing in a characteristic manner in the document set may be used directly. Alternatively, analysis units appearing in a characteristic manner in the document set may be combined and used as one characteristic expression. In this example, a characteristic expression includes at least one word. A characteristic expression also includes information representing a dependency relation and/or a syntax relation between words.

A method of extracting characteristic expressions from a document set by the characteristic expression extraction section 2 is the same as that used in the text mining technique. The characteristic expression extraction section 2 may use any known method as a method of extracting characteristic expressions from a document set.

The clustering section 3 performs clustering on a plurality of characteristic expressions extracted by the characteristic expression extraction section 2 in such a manner that characteristic expressions, in which sentences to be referred to as original sentences are the same, are compiled in one cluster, based on the similarity in the original document sets which are document sets including the respective characteristic expressions, of the document set input by the document set input section 1. This means that the clustering section 3 performs clustering on the characteristic expressions such that characteristic expressions, from which the same sentence can be output as an original sentence, constitute the same cluster (group) based on the degree of similarity between the document sets including the original sentences which are sentences serving as the base of extracting the respective characteristic expressions, of the document set.

Specifically, the clustering section 3 includes an appearance document vector creation section 31 and a characteristic expression clustering section 32.

For each of the combinations of characteristic expressions extracted by the characteristic expression extraction section 2 and documents constituting the document set, the appearance document vector creation section 31 acquires characteristic expression inclusion information indicating whether or not the document includes the characteristic expression (that is, the characteristic expression appears in the document). In this example, the characteristic expression inclusion information is set to “1” if a characteristic expression is included in the document, and set to “0” if a characteristic expression is not included in the document.

Then, the appearance document vector creation section 31 generates, for each characteristic expression, an appearance document vector in which the characteristic expression inclusion information acquired with respect to the characteristic expression serves as an element.

In the present example, as an element of the appearance document vector, while a binary value (“0” or “1”) indicating whether or not the characteristic expression is included in the document is used as the characteristic expression inclusion information, it is also possible to use a multi-valued value such as a value based on a frequency of appearance of a characteristic expression in the document (for example, tf-idf (Term Frequency-Inverse Document Frequency) value) as an element of the appearance document vector.

The characteristic expression clustering section 32 calculates a degree of similarity representing a degree of similarity between original document sets, each of which is a document set including each characteristic expression, based on the appearance document vector (that is, characteristic expression inclusion information) generated by the appearance document vector creation section 31.

For example, the characteristic expression clustering section 32 calculates an inverse of the magnitude (that is, a square root of the sum of the values calculated by squaring each of the elements) of the difference between an appearance document vector generated with respect to a first characteristic expression and an appearance document vector generated with respect to a second characteristic expression (that is, a vector in which a difference between the respective elements serves as an element).

Then, the characteristic expression clustering section 32 performs clustering such that a plurality of characteristic expressions, in which the calculated degree of similarity is larger than a preset reference degree of similarity, are compiled in one cluster. In this example, the characteristic expression clustering section 32 stores the characteristic expression in association with identification information for identifying the cluster, in the storage device.

The clustering result output section 4 outputs the characteristic expressions clustered by the characteristic expression clustering section 32 by each cluster. This means that the clustering result output section 4 outputs, by each cluster, characteristic expressions compiled in the cluster.

Further, the clustering result output section 4 receives, by each cluster, an output instruction input by a user. Upon receiving the output instruction, the clustering result output section 4 outputs a sentence (original sentence) including the characteristic expressions compiled in the cluster which is a target of output instruction, of the document set.

Next, operation of the text mining device 100 described above will be given. The CPU of the text mining device 100 is adapted to execute the text mining program shown in the flowchart of FIG. 2.

Specifically, when beginning processing of the text mining program, the CPU receives text information at step A1. In this example, description will be continued on an assumption that the CPU receives a document set relating to the “measures against global warming” of June, 2007.

Then, the CPU extracts characteristic expressions from the received document set (step A2). Specifically, the CPU converts the received document set into a tree structure by a syntax analysis. Then, the CPU counts the frequency with respect to each of the partial trees included in the tree structure (in this example, an analysis unit becomes a partial tree of the syntax tree obtained from a result of the syntax analysis). Further, the CPU extracts characteristic expressions based on the degrees of frequencies calculated based on the frequencies and the size of the partial trees.

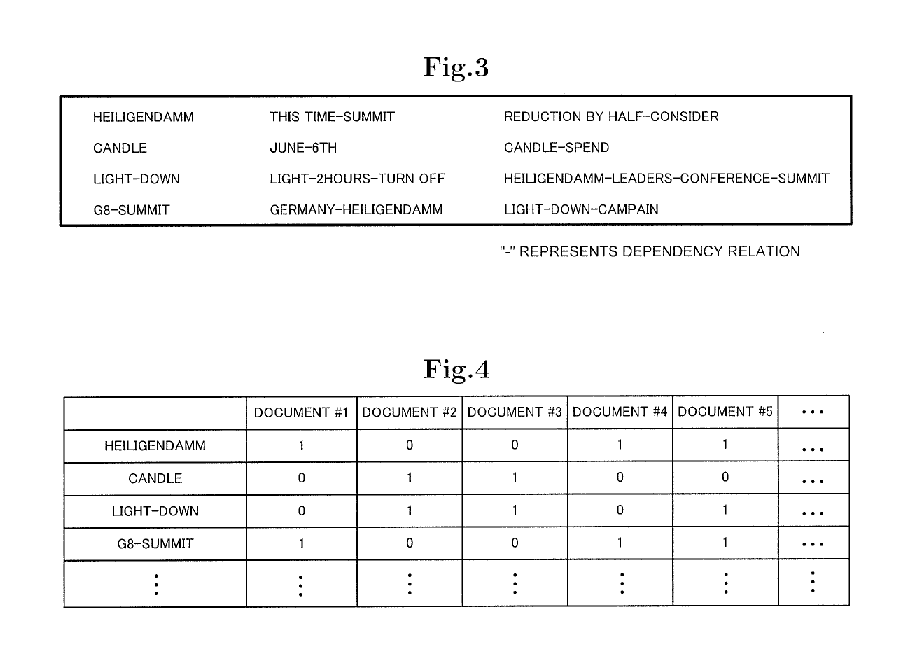

Now, description will be continued on an assumption that the CPU extracts 12 pieces of characteristic expressions as shown in FIG. 3. In FIG. 3, a hyphen “-” shown in the characteristic expressions represents a dependency relation.

Then, the CPU generates an appearance document vector with respect to each of the extracted characteristic expressions (step A3). In this example, description will be continued on an assumption that the CPU generates appearance document vectors as shown in FIG. 4.

Then, the CPU performs clustering on the characteristic expressions based on the generated appearance document vectors (step A4). Specifically, the CPU calculates a degree of similarity based on the appearance document vector with respect to each of arbitrary combinations of the characteristic expressions. Then, the CPU performs clustering such that the characteristic expressions constituting a combination, in which the calculated degree of similarity exceeds the reference degree of similarity, are compiled in the same cluster.

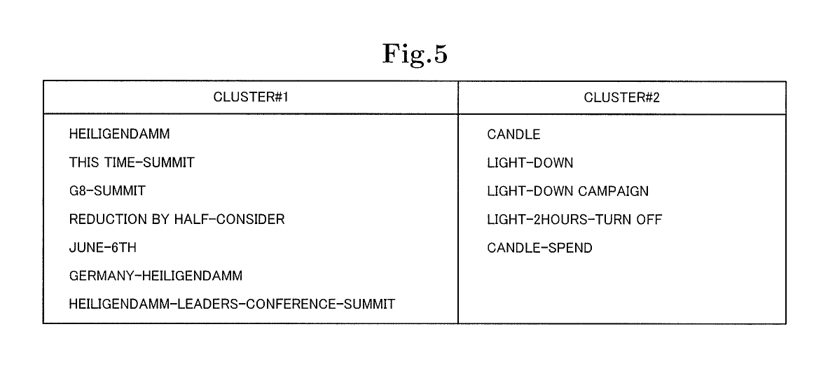

In this example, as shown in FIG. 5, description will be continued on an assumption that the CPU puts the characteristic expressions in two clusters (cluster #1 and cluster #2). That is, it is assumed that degrees of similarities calculated with respect to the combinations including “Heiligendamm” and “G8-Summit” and degrees of similarities calculated with respect to the combinations including “candle”, “light-down”, and the like are larger than the reference degree of similarity.

Then, for each cluster, the CPU outputs the characteristic expressions complied in that cluster (step A5). In this example, the CPU outputs an image in which the characteristic expressions compiled in each cluster are arranged in the area set for the cluster (allows the image to be displayed on the display).

Then, when the CPU receives an output instruction including information for identifying a cluster, the CPU outputs an original sentence which is a sentence containing the characteristic expressions compiled in the cluster identified by the output instruction (that is, a target of the output instruction), of the document set.

Accordingly, in the present example, a user is able to view the original sentence corresponding to all of the characteristic expressions by inputting output instructions the number of times corresponding to the number of clusters (that is, twice). Consequently, it is possible to reduce the probability that the user repeatedly views the same original sentence.

It should be noted that if the text mining device is adapted to output an original sentence including a characteristic expression each time the characteristic expression appears, the user needs to input an output instruction for each characteristic expression. Accordingly, in the above-described case, the user has to input output instructions 12 times. In that case, the probability that the user repeatedly views the same original sentence becomes relatively high.

Further, in the text mining device described in Patent Document 1, as “Heiligendamm” and “Germany-Heiligendamm” has an inclusion relation, “Heiligendamm” and “Germany-Heiligendamm” can be compiled in the same cluster. However, as “Heiligendamm” and “reduction by half-consider” do not have an inclusion relation or a duplication relation, such a text mining device cannot compile “Heiligendamm” and “reduction by half-consider” in the same cluster.

Accordingly, the number that the text mining device described in Patent Document 1 outputs original sentences becomes larger than that of the text mining device 100 according to the first exemplary embodiment described above. As such, the probability that the user repeatedly views the original sentence when the user uses the text mining device described in Patent Document 1 is higher than that of the case of the text mining device 100 according to the first exemplary embodiment described above.

As described above, according to the first exemplary embodiment of the text mining device of the present invention, the text mining device 100 outputs, by each cluster, an original sentence which is a sentence including the characteristic expressions compiled in the cluster. Accordingly, compared with a text mining device adapted to output an original sentence including a characteristic expression by each characteristic expression, it is possible to reduce the probability that the user repeatedly views the same original sentence. Further, it is also possible to reduce the number of times that the user views the original sentence (for example, the number of times that the user inputs output instructions).

Further, according to the first exemplary embodiment, the text mining device 100 is adapted to output, by each cluster, the characteristic expressions compiled in the cluster. As such, the user is also able to understand the outline of the document set by viewing the characteristic expressions compiled in the cluster, without viewing the original sentence.

### Second Exemplary Embodiment

Next, a text mining device according to a second exemplary embodiment of the present invention will be described. The text mining device according to the second exemplary embodiment differs from the text mining device of the first exemplary embodiment in that the device outputs characteristic sentences including characteristic expressions in addition to, or in replacement of, the characteristic expressions. Accordingly, description will be given below by focusing on such a difference.

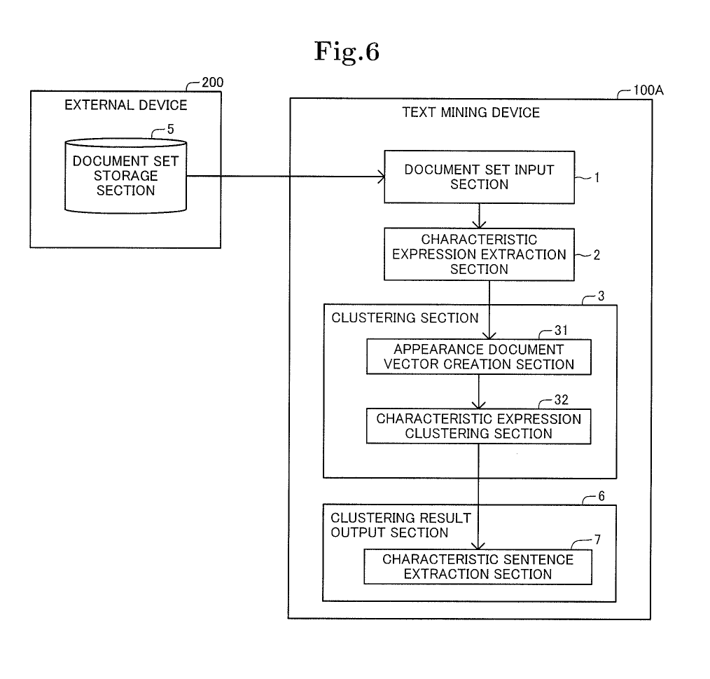

As shown in FIG. 6, functions of the text mining device 100A according to the second exemplary embodiment includes a clustering result output section 6, in replacement of the clustering result output section 4 included in the text mining device 100 according to the first exemplary embodiment. Further, similar to the text mining device 100, the functions of the text mining device 100A include the document set input section 1, the characteristic expression extraction section 2, and the clustering section 3.

Further, the clustering result output section 6 includes a characteristic sentence extraction section 7. The characteristic sentence extraction section 7 extracts, for each cluster, a characteristic sentence including the characteristic expressions compiled in the cluster. In this example, the characteristic sentence extraction section 7 extracts one of the sentences included in the document set, which is a target of text mining, as a characteristic sentence. At this time, the characteristic sentence extraction section 7 extracts a sentence including the largest number of characteristic expressions compiled in the cluster, as a characteristic sentence.

In the present example, while the characteristic sentence extraction section 7 is adapted to extract a characteristic sentence based on the number of characteristic expressions included in a sentence, the characteristic sentence extraction section 7 may be adapted to use, as a reference when extracting a characteristic sentence, at least one value of the number of characters consisting a sentence and a degree of characteristic which is a level representing the characteristic of the document set by a characteristic expression, in addition to the number of characteristic expressions of the cluster included in the sentence. It should be noted that the grounds for using the number of characters consisting a characteristic sentence as a parameter for extracting a characteristic sentence are to achieve effects such as prevention of a problem that a too long sentence may be selected when selecting a characteristic sentence only using the number of characteristic expressions as a reference, or adjusting the length of a characteristic sentence to be output to be a length suitable for reading according to the purpose of using the present invention or according to the situation. Considering from the characteristic expressions included in a characteristic sentence, while the characteristic sentence is one of the original sentences, it is characterized in that the sentence is a common original sentence for the characteristic expressions in the cluster. If there is no characteristic sentence including all characteristic expressions belonging to one cluster, a plurality of sentences may be extracted as the characteristic sentences of the cluster.

The clustering result output section 6 outputs, for each cluster, a characteristic sentence extracted by the characteristic sentence extraction section 7. In that case, the clustering result output section 6 may also output the characteristic expressions of the respective clusters together.

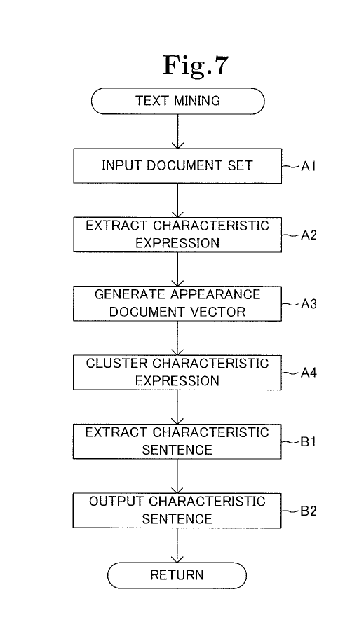

Next, operation of the text mining device 100A according to the second exemplary embodiment will be described. The CPU of the text mining device 100A is adapted to execute a text mining program shown by the flowchart of FIG. 7. In this program, step A5 of the program shown in FIG. 2 is replaced with step B1 and step B2.

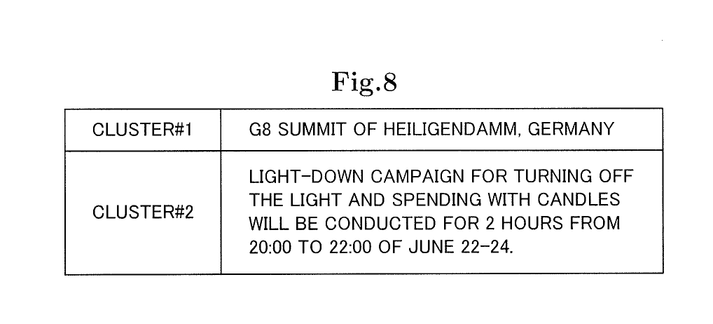

This means that the CPU executes processing of step A1 to step A2, similar to the case of the first exemplary embodiment. Then, at step B1, the CPU extracts, for each cluster, a characteristic sentence including the characteristic expressions compiled in the cluster. For example, the CPU extracts a characteristic sentence for each cluster as shown in FIG. 8.

Then, at step B2, the CPU outputs the extracted characteristic sentences (allows them to be displayed on a display, transmits them to another computer over a network, or the like).

As described above, according to the text mining device of the second exemplary embodiment, a user is able to understand the outline of text information by viewing a characteristic sentence which is a common original sentence to the characteristic expressions of each cluster, without viewing the original sentences of the same number of that of the characteristic expressions. Further, according to the second exemplary embodiment, compared with the case where the text mining device is adapted to extract the original sentence for each characteristic expression, it is possible to extract a characteristic sentence representing the outline of the text information better. This is because characteristic expressions are clustered based on the appearance document vector of each characteristic expression whereby characteristic expressions having a high relation are compiled. For each cluster in which characteristic expressions are compiled, as an original sentence including a large number of characteristic expressions included in that cluster is extracted as a characteristic sentence, a characteristic sentence representing a cluster in which characteristic expressions having a high relation can be output in the present embodiment, compared with a method of simply outputting the original sentence for each characteristic expression or a method of selecting an original sentence including a large number of arbitrary characteristic expressions not limited by a cluster.

It should be noted that in a variation of the second exemplary embodiment, the text mining device 100A may be adapted to output characteristic sentences in addition to characteristic expressions.

### Third Exemplary Embodiment

Next, a text mining device according to a third exemplary embodiment of the present invention will be described. The text mining device according to the third exemplary embodiment is different from the text mining device of the second exemplary embodiment in that the device newly creates a characteristic sentence. As such, description will be given below focusing on such a difference.

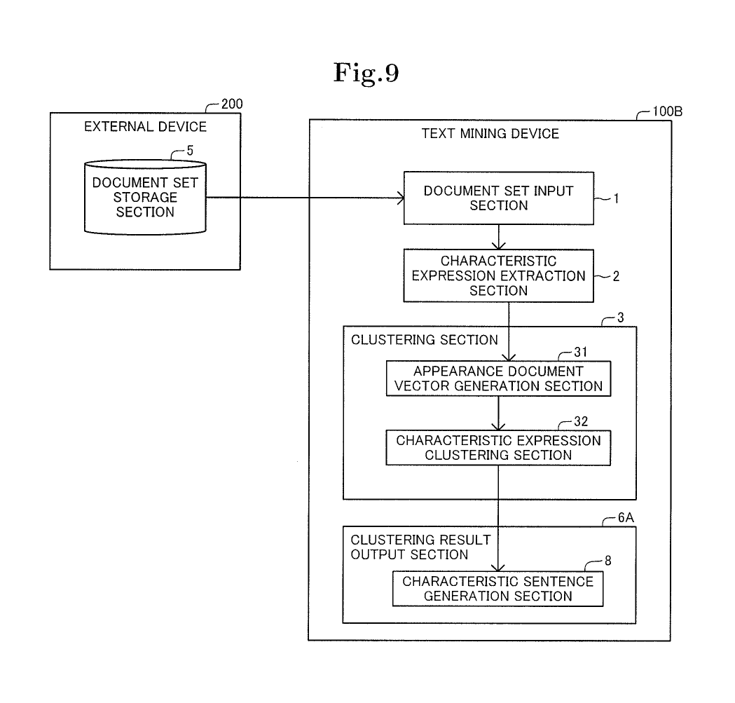

As shown in FIG. 9, the functions of the text mining device 100B according to the third exemplary embodiment include a clustering result output section 6A in replacement of the clustering result output section 6 included in the text mining device 100A of the second exemplary embodiment. Further, similar to the text mining device 100A, the functions of the text mining device 100B include the document set input section 1, the characteristic expression extraction section 2, and the clustering section 3.

Further, the clustering result output section 6A includes a characteristic sentence generation section 8. The characteristic sentence generation section 8 generates, for each cluster, a characteristic sentence based on the characteristic expressions compiled in the cluster. In the present embodiment, the characteristic sentence generation section 8 generates a characteristic sentence by linking the characteristic expressions compiled in a cluster. The characteristic sentence generation section 8 may be adapted to generate a characteristic sentence by adding, to the characteristic expressions compiled in a cluster, words (including particles) located immediately before or immediately after the characteristic expressions in the original sentence including the characteristic expressions.

It should be noted that an exemplary technique of generating a characteristic sentence from characteristic expressions is disclosed in JP 2006-92468 A. As such, the details thereof are not described in this description.

For each cluster, the clustering result output section 6A outputs a characteristic sentence generated by the characteristic sentence generation section 8.

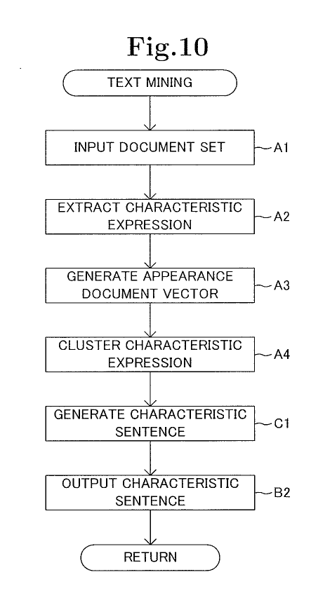

Then, operation of the text mining device 100B according to the third exemplary embodiment will be described. The CPU of the text mining device 100B is adapted to execute a text mining program shown by the flowchart of FIG. 10. In this program, step B1 of the program shown in FIG. 7 is replaced with step C1.

This means that the CPU executes processing of steps A1 to step A4, similar to the case of the second exemplary embodiment. Then, at step C1, the CPU generates, for each cluster, a characteristic sentence including the characteristic expressions compiled in the cluster.

Specifically, the CPU extracts partial character strings, each from a word immediately before a characteristic expression to a word immediately after the characteristic expression from the original sentence (contained in the document) including the characteristic expression. Then, if the extracted partial character strings includes the same word, the CPU links the extracted partial character strings, using the word as a linking part. If they do not include the same word, the CPU directly links the extracted partial character strings. When linking, the CPU may change the inflection of the word or the end of the word included in the respective partial character strings so as to satisfy the grammatical restrictions related to the connection of the words. It should be noted that the sentence generation technique itself is a well-known technique as exemplary described in Patent Document 2, and so the details thereof are not described herein.

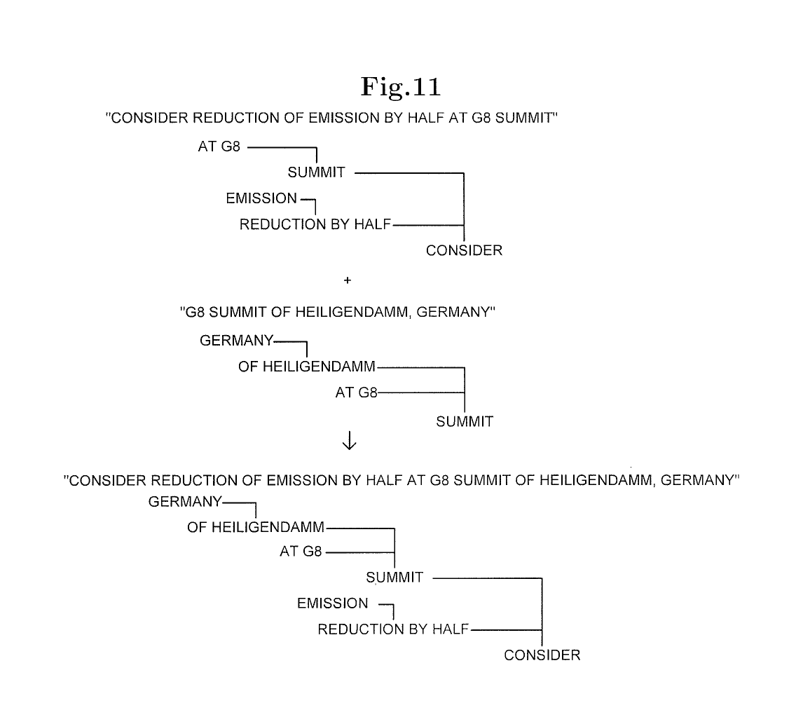

For example, as shown in FIG. 11, the CPU extracts “G8 Summit of Heiligendamm, Germany” and “consider reduction of emission by half at G8 Summit” as partial character strings from a word immediately before a characteristic expression and a word immediately after the characteristic expression. Then, the CPU links “G8 Summit of Heiligendamm, Germany” and “consider reduction of emission by half at G8 Summit”, using the same character string “G8 Summit” of the extracted partial character strings as a linking part. Thereby, the CPU generates “consider reduction of emission by half at G8 Summit of Heiligendamm, Germany” as a characteristic sentence.

Then, at step B2, the CPU outputs the generated characteristic sentence (allows it to be displayed on a display, transmits it to another device connected over a network, or the like).

As described above, according to the text mining device of the third exemplary embodiment, a user is able to understand the outline of the text information by viewing the characteristic sentence, without viewing the original sentence.

If there is no sentence including a plurality of characteristic expressions in the sentences represented by a document set, a characteristic sentence extracted by the text mining device 100A may not indicate the outline of the document set sufficiently. However, according to the text mining device 100B of the third exemplary embodiment, the device is able to output a characteristic sentence including a plurality of characteristic expressions even in that case. Accordingly, a user is able to understand the outline of the document set appropriately by viewing the characteristic sentence.

### Fourth Exemplary Embodiment

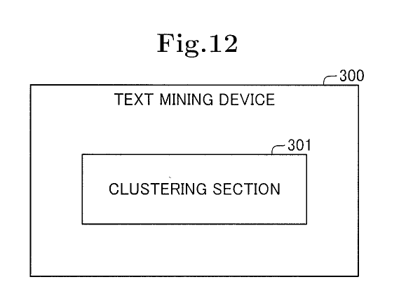

Next, a text mining device according to a fourth exemplary embodiment of the present invention will be described with reference to FIG. 12.

A text mining device 300 according to the fourth exemplary embodiment includes

a clustering section (clustering means) 301 which performs clustering on a plurality of characteristic expressions extracted from a document set such that characteristic expressions, in which sentences to be referred to as original sentences are the same, are compiled in one cluster, based on the similarity in original document sets which are sets of documents including the respective characteristic expressions, the documents being of the document set.

According to this configuration, the text mining device 300 can be adapted to output, for each cluster, an original sentence which is a sentence including the characteristic expressions compiled in the cluster. Accordingly, compared with a text mining device adapted to output, for each characteristic expression, an original sentence including the characteristic expression, the probability that a user repeatedly views the same original sentence can be reduced reliably. Further, it is also possible to reduce the number of times that a user views the original sentences.

In that case, it is preferable that the clustering means is adapted to compile, in one cluster, characteristic expressions each having a degree of similarity larger than a predetermined reference degree of similarity, the degree of similarity representing a degree that the original document sets which are sets of documents including the respective characteristic expressions are similar to each other.

In that case, it is preferable that the clustering means is adapted to acquire, with respect to each combination of the document and the characteristic expression, characteristic expression inclusion information representing whether or not the document includes the characteristic expression, and calculate the degree of similarity based on the acquired characteristic expression inclusion information.

In that case, it is preferable that the text mining device includes a characteristic expression output means for outputting, for each of the clusters, the characteristic expressions compiled in the cluster.

According to this configuration, a user is able to understand the outline of the document set by viewing a plurality of characteristic expressions compiled in a cluster, without viewing the original sentence.

In that case, it is preferable that the text mining device includes an original sentence output means for outputting, for each of the clusters, the original sentence including the characteristic expression compiled in the cluster.

According to this configuration, compared with a text mining device adapted to output, for each characteristic expression, an original sentence including the characteristic expression, the probability that a user repeatedly views the same original sentence can be reduced reliably. Further, it is also possible to reduce the number of times that a user views the original sentences.

In that case, it is preferable that the characteristic expression output means is adapted to extract, for each of the clusters, an original sentence including a plurality of characteristic expressions compiled in the cluster as a characteristic sentence, and output the extracted characteristic sentence for each of the clusters.

According to this configuration, a user is able to understand the outline of the document set by viewing the characteristic sentence.

In that case, it is preferable that the characteristic expression output means is adapted to extract the characteristic sentence for each of the clusters based on at least one of the number of characteristic expressions, belonging to the cluster, included in a sentence; the number of characters constituting a sentence; and a degree of characteristic which indicates a degree that the characteristic expression represents the characteristic of the document set.

A sentence including a larger number of characteristic expressions belonging to the cluster represents the cluster better. As such, it is preferable to extract a characteristic sentence based on the number of characteristic expressions included in a sentence.

Further, if the number of characters constituting a sentence is too small (that is, a sentence is too short), it is highly likely that a user cannot acquire desired information even if the user views the sentence. On the other hand, if the number of characters constituting a sentence is too large (that is, a sentence is too long), the time required for viewing the sentence by a user becomes too long. Accordingly, it is preferable to extract a characteristic sentence based on the number of characters constituting a sentence.

Further, a sentence having a higher degree of characteristic, which indicates a degree that a characteristic expression represents the characteristic of the document set, represents the cluster including the characteristic expression better. Accordingly, it is preferable to extract a characteristic sentence based on the degree of characteristic.

Further, in another aspect of the text mining device described above,

it is preferable that the characteristic expression output means is adapted to generate, for each of the clusters, a characteristic sentence based on the characteristic expressions compiled in the cluster, the characteristic sentence including at least one of the characteristic expressions.

In that case, it is preferable that the characteristic expression output means is adapted to generate, for each of the clusters, the characteristic sentence by linking the characteristic expressions compiled in the cluster.

Further, a text mining method, which is another aspect of the present invention, includes

performing clustering on a plurality of characteristic expressions extracted from a document set such that characteristic expressions, in which sentences to be referred to as original sentences are the same, are compiled in one cluster, based on the similarity in original document sets which are sets of documents including the respective characteristic expressions, the documents being of the document set.

In that case, it is preferable that the text mining method includes compiling, in one cluster, characteristic expressions each having a degree of similarity larger than a predetermined reference degree of similarity, the degree of similarity representing a degree that the original document sets which are sets of documents including the respective characteristic expressions are similar to each other.

In that case, it is preferable that the text mining method includes acquiring, with respect to each combination of the document and the characteristic expression, characteristic expression inclusion information representing whether or not the document includes the characteristic expression, and calculating the degree of similarity based on the acquired characteristic expression inclusion information.

Further, a text mining program, which is another aspect of the present invention, is a program for causing a text mining device to realize

a clustering means for performing clustering on a plurality of characteristic expressions extracted from a document set such that characteristic expressions, in which sentences to be referred to as original sentences are the same, are compiled in one cluster, based on the similarity in original document sets which are sets of documents including the respective characteristic expressions, the documents being of the document set.

In that case, it is preferable that the clustering means is adapted to compile, in one cluster, characteristic expressions each having a degree of similarity larger than a predetermined reference degree of similarity, the degree of similarity representing a degree that the original document sets which are sets of documents including the respective characteristic expressions are similar to each other.

In that case, it is preferable that the clustering means is adapted to acquire, with respect to each combination of the document and the characteristic expression, characteristic expression inclusion information representing whether or not the document includes the characteristic expression, and calculate the degree of similarity based on the acquired characteristic expression inclusion information.

As even an invention of a text mining method or a text mining program having the above-described configurations exhibits the same action as that of the text mining device described above, such an invention is able to achieve the object of the present invention described above.

While the present invention has been described with reference to the exemplary embodiments thereof, the present invention is not limited to these embodiments. It will be understood by those skilled in the art that various changes in form and details may be made therein without departing from the scope of the present invention.

For example, in the respective exemplary embodiments, while the text mining devices 100, 100A, 100B, and 300 are adapted to output an original sentence upon receiving an output instruction, the devices may be adapted to sequentially output an original sentence each time a predetermined time period elapses.

It should be noted that while the respective functions of each of the text mining devices 100, 100A, 100B, and 300 are realized by the CPU executing a program (software), such functions may be realized by hardware such as circuits.

Further, while a program is stored in a storage device in each of the exemplary embodiments described above, it may be stored in a computer readable recording medium. For example, recording media are portable media including flexible disks, optical disks, magneto optical disks, and semiconductor memories.

Further, as other variations of the exemplary embodiments described above, any combinations of the exemplary embodiments and the variations may be adopted.

This application is based upon and claims the benefit of priority from Japanese patent application No. 2009-160811, filed on Jul. 7, 2009, the disclosure of which is incorporated herein in its entirety by reference.

### INDUSTRIAL APPLICABILITY

The present invention is applicable to text mining devices and the like which extract, from a document set, information representing the outline of the document set.

### REFERENCE NUMERALS

1 document set input section
2 characteristic expression extraction section
3 clustering section
4 clustering result output section
5 document set storage section
6 clustering result output section
6A clustering result output section
7 characteristic sentence extraction section
8 characteristic sentence generation section
31 appearance document vector creation section
32 characteristic expression clustering section
100 text mining device
100A text mining device
100B text mining device
200 external device
300 text mining device
301 clustering section

1. A text mining device, comprising
a clustering unit that performs clustering on a plurality of characteristic expressions extracted from a document set such that characteristic expressions, in which sentences to be referred to as original sentences are the same, are compiled in one cluster, based on a similarity in original document sets which are sets of documents including the respective characteristic expressions, the documents being of the document set.

2. The text mining device according to claim 1, wherein
the clustering unit is adapted to compile, in one cluster, characteristic expressions each having a degree of similarity larger than a predetermined reference degree of similarity, the degree of similarity representing a degree that the original document sets which are sets of documents including the respective characteristic expressions are similar to each other.

3. The text mining device according to claim 1, wherein
the clustering unit is adapted to acquire, with respect to each combination of the document and the characteristic expression, characteristic expression inclusion information representing whether or not the document includes the characteristic expression, and calculate the degree of similarity based on the acquired characteristic expression inclusion information.

4. The text mining device according to claim 1, further comprising
a characteristic expression output unit that outputs, for each of the clusters, the characteristic expression compiled in the cluster.

5. The text mining device according to claim 1, further comprising
an original sentence output unit that outputs, for each of the clusters, the original sentence including the characteristic expression compiled in the cluster.

6. The text mining device according to claim 4, wherein
the characteristic expression output unit is adapted to extract, for each of the clusters, an original sentence including a plurality of characteristic expressions compiled in the cluster as a characteristic sentence, and output the extracted characteristic sentence for each of the clusters.

7. The text mining device according to claim 6, wherein
the characteristic expression output unit is adapted to extract the characteristic sentence for each of the clusters based on at least one of the number of characteristic expressions, belonging to the cluster, included in a sentence; the number of characters constituting a sentence; and a degree of characteristic which indicates a degree that the characteristic expression represents the characteristic of the document set.

8. The text mining device according to claim 4, wherein
the characteristic expression output unit is adapted to generate, for each of the clusters, a characteristic sentence based on the characteristic expressions compiled in the cluster, the characteristic sentence including at least one of the characteristic expressions.

9. The text mining device according to claim 8, wherein
the characteristic expression output unit is adapted to generate, for each of the clusters, the characteristic sentence by linking the characteristic expressions compiled in the cluster.

10. A text mining method, comprising
performing clustering on a plurality of characteristic expressions extracted from a document set such that characteristic expressions, in which sentences to be referred to as original sentences are the same, are compiled in one cluster, based on a similarity in original document sets which are sets of documents including the respective characteristic expressions, the documents being of the document set.

11. The text mining method according to claim 10, wherein
the method includes compiling, in one cluster, characteristic expressions each having a degree of similarity larger than a predetermined reference degree of similarity, the degree of similarity representing a degree that the original document sets which are sets of documents including the respective characteristic expressions are similar to each other.

12. The text mining method according to claim 10, wherein
the method includes acquiring, with respect to each combination of the document and the characteristic expression, characteristic expression inclusion information representing whether or not the document includes the characteristic expression, and calculating the degree of similarity based on the acquired characteristic expression inclusion information.

13. A computer-readable medium storing a text mining program comprising instructions for causing a text mining device to realize
a clustering unit that performs clustering on a plurality of characteristic expressions extracted from a document set such that characteristic expressions, in which sentences to be referred to as original sentences are the same, are compiled in one cluster, based on a similarity in original document sets which are sets of documents including the respective characteristic expressions, the documents being of the document set.

14. The medium according to claim 13, wherein
the clustering unit is adapted to compile, in one cluster, characteristic expressions each having a degree of similarity larger than a predetermined reference degree of similarity, the degree of similarity representing a degree that the original document sets which are sets of documents including the respective characteristic expressions are similar to each other.

15. The medium according to claim 13, wherein
the clustering unit is adapted to acquire, with respect to each combination of the document and the characteristic expression, characteristic expression inclusion information representing whether or not the document includes the characteristic expression, and calculate the degree of similarity based on the acquired characteristic expression inclusion information.

16. A text mining device, comprising
clustering means for performing clustering on a plurality of characteristic expressions extracted from a document set such that characteristic expressions, in which sentences to be referred to as original sentences are the same, are compiled in one cluster, based on a similarity in original document sets which are sets of documents including the respective characteristic expressions, the documents being of the document set.
